(19) United States
(12) Patent Application Publication
(10) Pub. No.: US 2011/0194120 A1
(43) Pub. Date: Aug. 11, 2011

(54) METHOD AND DEVICE FOR PHASE MEASUREMENT

(75) Inventors: Vajira Samapth AMARATUNGA, Dandenong (AU); Haroldo Takashi Hattori, Canberra (AU); Malin Premaratne, Alphington (AU); Hark Hoe Tan, Garran (AU); Chennupati Jagadish, O'Connor (AU)

(73) Assignees: MONASH UNIVERSITY, Clayton (AU); THE AUSTRALIAN NATIONAL UNIVERSITY, Canberra (AU)

(21) Appl. No.: 12/470,178

(22) Filed: May 21, 2009

(51) Int. Cl. G01B 9/02

(52) U.S. Cl. 356/477

(57) ABSTRACT

The present invention relates to the field of phase measurement, particularly optical phase measurement. In one form, the invention relates to a method and device for measuring the phase between distinct signals by converting phase variations between the signals into amplitude variations. In one embodiment the invention provides a method of arranging the structure of a two-dimensional or three-dimensional crystal to measure the phase between signals, comprising the steps of (i) providing a respective waveguide for each signal and (ii) providing a micro-cavity array arranged to provide a resonance output in response to the phase of the signals. The invention has application to a wide range of apparatus and devices across many industries including communications, food technology, pharmacology, medicine and biology.

### FIELD OF INVENTION

The present invention relates to the field of phase measurement, particularly optical phase measurement.

In one form, the invention relates to a method of measuring the phase between distinct signals by converting phase variations between the signals into amplitude variations.

In another form, the invention relates to a photonic crystal for converting phase variations between distinct signals into amplitude variations and devices incorporating said photonic crystal.

In one particular aspect the present invention is suitable for use as a photonic crystal phase detector in optical communications, optical measurement and optical sensing.

It will be convenient to hereinafter describe the invention in relation to optical communications and the use of optical phase detectors, however it should be appreciated that the present invention is not so limited and has a wide range of application to many fields and many different devices. Furthermore, while the invention is described with particular reference to the use of gallium arsenide (GaAs) photonic crystals, the invention is not so limited and can be used in relation to a wide range of dielectric materials.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

### Phase Detectors Generally

A phase detector generates a voltage signal that represents the difference in phase between two signal inputs. Detection of phase differences is used in many applications including motor control, radar systems, telecommunications systems, servo mechanisms and demodulators.

Phase detectors are typically either electronic or optical. Optical phase detectors are basically interferometers—devices that diagnose the properties of two or more lasers or waves by studying the pattern of interference created when they are superimposed. For pulsed (amplitude modulated) light, it can be used to measure the phase between carriers. It is also possible to measure the delay between the envelopes of two short optical pulses by means of cross correlation in a nonlinear crystal. And it is possible to measure the phase between the envelope and the carrier of an optical pulse, by sending a pulse into a nonlinear crystal. There the spectrum gets wider and at the edges the shape depends significantly on the phase.

Development of the Technology

Optical phase detectors are used in a wide range of applications that rely on optical signals and the phase information for detection or encryption such as communication, measurement or sensing systems.

The development of optical phase detector technology can be conveniently described using optical fibre communication as an example. The first optical fibre communication systems used on-off shift-keying modulation techniques. At the transmission end, the current of the light source (initially an incoherent light source such as a light emitting diode and later on laser diodes) was directly modulated, generating streams of optical pulses that were transmitted through optical fibres.

Improvements in the coherence of laser diodes allowed the generation of light with much more stability: single frequency, high power and stable phase optical beams could now be generated. This opened up the possibility of modulating the phase of the optical carrier and to transmit information by using modulation schemes such as differential phase shift keying and phase shift keying.

In order to recover the information contained in the phase of the carrier, there is a need to employ phase detectors in the receiver end. Typical phase detectors convert variations in phase of a given waveform into variations in amplitude. Variations in amplitude can be detected much more easily.

In recent years, techniques such as on-off shift keying modulation of the optical carrier has been replaced by advanced modulation techniques such as differential phase shift keying (DPSK) and orthogonal frequency division multiplexing (OFDM). DPSK data format is particularly favoured because of its improved receiver sensitivity and higher tolerance to fiber nonlinearities. These advanced modulation techniques in modern optical communication systems are dependent on accurate phase detection of optical signals. At present, phase detection in these systems is performed using a combination of a number of pieces of equipment.

### Phase Detectors

Typical phase detectors that are currently in use include those based on Mach Zehnder or Michelson interferometers. Basically, the incoming modulated light is split into two arms of the interferometers. In case of DPSK, the signal in one of the arms is delayed and recombined with the signal in the other arm, converting variations in phase into variations in amplitude.

Another type of phase detector currently in use is based upon micro-ring resonators. It is a variation of the Mach Zehnder interferometer and converts variations in phase into variations in amplitude. However, the carrier frequency is also shifted in this approach.

A very recently developed phase detector utilises dark and bright states. In this new approach, light is split into two arms and delayed in one of the arms. The light from both arms are coupled into an array of resonators, exciting their dark and bright states.

U.S. Pat. No. 6,147,755 relates to a dynamic optical phase state detector and method for using optical interference with an optical frequency shifter (by radio frequency (RF) modulation technique) that changes frequency up or down by an amount corresponding to the modulation frequency. Specifically, the method includes splitting the signal using a 3 dB splitter which feeds into two beams. One beam is applied to a photonic structure which changes the phase of that beam. The beams are then combined using a phase interference method (i.e. two beams are allowed to interfere with each other and combine into a single beam). An optical beat frequency is generated which corresponds to the frequency of the RF modulator. The phase of the detected beat frequency relative to the original RF modulation signal contains the phase information created by the photonic device. The RF beat frequency and the RF modulation signal is converted to digital waveforms that are digitally divided by an equal number such that the resultant outputs are square waves. The divided waves are applied to an exclusion device or gate that produces a pulse wave with the period correspond to the phase difference of the original RF frequencies.

This method has the disadvantage of requiring a large number of components and pieces of equipment such as 3 dB splitters, photonic structures, interferometers, frequency generators, signal converters and logic gates which makes the final set up bulky. Furthermore all the supporting equipment needs external power.

U.S. Pat. No. 5,392,116 relates to phase interference measurement using profile heights and displacements in the nanometer range. The optical measurements are made using the phase differences generated due to the height differences or displacements. In use, the detector initially uses a beam splitter to split differently polarized light beams into several beams. These beams are passed through a lens to provide laterally displaced parallel light beams which impinge on light sensors. A phase shifter and a polarizer are placed between the lens and sensors. The phase shifter shifts the phase of the beams depending on the position and polarization and the polarizer causes a change in the intensity of the beam. Differences in intensity measured by the sensor are related to the phase difference between the beams and these differences are then converted to the height or displacement measurement.

U.S. Pat. No. 6,891,149 and International patent application WO 00/17613 disclose phase detectors comprising a voltage-tunable electro-optic phase modulator, optical waveguide on an integrated optic substrate, polarization modulator and photodetectors. The device combines two optical signals using a coupler. The two outputs are converted into two corresponding electrical signals. The two electric signals are combined to generate a signal which corresponds to the relative phase difference between the combined optical inputs.

One of the disadvantages of this invention, and many other modern optical phase detectors is that most of the components used are electrically driven and therefore need external power.

### Size

Another disadvantage of many modern optical phase detectors is their lack of compactness. Integrated optical devices and systems are essential for harnessing the full potential of photonics including transmission and manipulation of data at very high speeds. In order to fabricate these integrated optical devices, light must be confined in very, very small regions by either using total internal reflection or periodic bandgap effect. The current size of optical phase detectors is adequate for the communications industry, but not sufficiently small for a range of industries including computing, defence and biology. Furthermore, current optical phase detectors are too large to be used in computer chip-scale applications.

### SUMMARY OF INVENTION

An object of at least one embodiment of the present invention is to provide a more compact device, such as a phase detector that enables the range of applications for the device to be extended, optimally from the communications sphere to the computing, defence, food science and biology spheres.

A further object of at least one embodiment of the present invention is to provide a device such as a phase detector that can be applied across the electromagnetic spectrum including optical and microwave applications, radio-frequency identification (RFID) and microwave signal modulation and demodulation.

A further object of at least one embodiment of the present invention is to alleviate at least one disadvantage associated with the related art.

It is an object of the embodiments described herein to overcome or alleviate at least one of the above noted drawbacks of related art systems or to at least provide a useful alternative to related art systems.

It is known that it is possible to create dark and bright states in photonic crystal micro-cavity arrays, the creation of these states depended upon the relative phase between the sources. It has now been found that these arrays can be modified for use as phase detectors to enable detection of the relative phase between two optical signals.

In a first aspect of embodiments described herein there is provided a method of arranging the structure of a crystal to measure the phase between signals, comprising the steps of (i) providing a respective waveguide for each signal and (ii) providing a micro-cavity array arranged to provide a resonance output in response to the phase of the signals.

In a second aspect of embodiments described herein there is provided a method of arranging the structure of a crystal to measure the phase between a pair of signals comprising the steps of;
(i) providing input waveguides adapted to pass respective signals,
(ii) providing a first cavity adapted to pass a characteristic of at least one signal, and
(iii) providing an output waveguide adapted to pass an output signal based on the characteristic of the at least one signal.

In a third aspect of embodiments described herein there is provided a method of, and crystal adapted for, measuring the phase between two or more signals, comprising the steps of passing the signals through at least two respective waveguides and at least one micro-cavity array in a crystal structure and measuring the resonance output in response to the phase of the signals.

In a fourth aspect of embodiments described herein there is provided a method of, and crystal adapted for, measuring the phase between two signals, comprising the step of passing each signal through respective input waveguides, a micro-cavity array and an output waveguide, the amplitude of the power passing through the output waveguide being dependent on the relative phase difference between the signals.

Preferably the crystal is a photonic crystal. Where used herein the term ‘photonic crystal’ refers to structures in which the index of refraction is periodic, the periodicity of the structure typically being in the order of the wavelength of the incoming signal. Typically a photonic crystal consists of transparent materials having a different refractive indexes. Micro-cavities are formed by point defects, and waveguides are formed by line defects in the photonic crystal structure.

The present invention is based on passing a single signal through each input waveguide. Input characteristics of a pair of signals pass to the micro-cavity where ‘whispering gallery like modes’ are created if the input waveguides have the same, or very similar frequencies.

The crystal structures suitable for use in the invention are preferably designed to operate on a single frequency with a narrow bandwidth. All other frequencies are suppressed or will decay exponentially in these structures.

Therefore existence of other frequencies, outside the designed bandwidth is not supported. Hence all frequencies not in the designed bandwidth will be suppressed (and will decay exponentially). Noise in optical signals has a low amplitude distribution over a wide frequency range. Therefore optical noise components that are not in the designed bandwidth will be suppressed. This leads to an enhanced signal-to-noise ratio (SNR) in the system. In optical communication systems, this will reduce the bit error ratio (BER) thus enhancing the signal quality.

The structure of the crystal of the present invention may be designed and scaled to operate at the desired frequency with a desired material combination. In particular, the scaling properties inherent in Maxwell's equation may be applied to photonic crystal design.

Typically when the crystal of the present invention is two-dimensional, the structure will have two input waveguides, a single micro-cavity and a single output waveguide. However when the crystal is three-dimensional, the structure may have several pairs of waveguides, each pair having a respective microcavity and an output waveguide.

In a fifth aspect of embodiments described herein there is provided a method of arranging a crystal comprising at least one waveguide and a micro-cavity array, including the step of calculating the structure of the crystal in accordance with Maxwell's equation, wherein the micro-cavity array is arranged to provide a resonance output in response to the phase of signals passed by respective waveguides.

Following from the application of Maxwell's equation fabrication of a suitable crystal structure, preferably a photonic crystal structure, can be carried out using any suitable dielectric material. In a preferred embodiment the crystal comprises elements of any one or more of Group 1 and Groups 5 to 9 of the periodic table. In a particularly preferred embodiment the crystal is fabricated from elements chosen from the group comprising Al, Ga, In, C, Si, Ge, N, P, As, Sb, O, S, Br, I. For example, the crystal may be chosen from the group comprising GaAs, InP, AlGaAs, AlGaAsP, InGaN, ZnO, LiIO₃, InAs or Si. However, the person skilled in the art will appreciate that it may be desirable to avoid the selection of a dielectric having an imaginary constant in the dielectric constant, such as ZnO, LiIO₃, InAs or Si.

The crystal structure may be two or three dimensional. In a preferred embodiment the crystal is a square lattice photonic crystal of dielectric material. Preferably the square lattice is designed to operate under transverse electric (TE) modes with the main magnetic field component along the y direction. The typical operating frequency is 10 to 15 Hz and the crystal may operate at any part of the electromagnetic spectrum.

For example, the crystal may consist of a GaAs core, an oxidized lower cladding, and a GaAs substrate. The oxidized and air regions confine light in the GaAs core region. The oxidised and air regions confine the signal within the GaAs core region. For example, the thickness of the GaAs core is typically 140 nm, and the oxidized layer is typically 450 nm (prior to oxidation).

Preferably the crystal is built on an epitaxially layered structure, that is, by deposition of a monocrystalline film on a monocrystalline substrate. A GaAs crystal for operation at a wavelength of 1040 may for example consist of square lattice air holes with lattice constant [symbol] =317 nm and air hole radius of 120 nm. The lattice constant can be changed to suit any operating frequency (wavelength) at which the crystal may operate.

Maxwell's equation can also be adapted to provide a general formulation for the relation between the properties of the crystal material (dielectric constant or refractive index) including the gap between holes and the radius of the holes.

In a sixth aspect of embodiments described herein there is provided a method of arranging a crystal, and the crystal, comprising at least one waveguide and a micro-cavity array, including the step of calculating the structure of the crystal by applying the relationship

$$g ( ϕ ) = {G}_{x}^{2} ( {cos}^{2} ϕ + ( \frac{{b}_{e}}{{a}_{e}} ) {sin}^{2} ϕ ) + {G}_{y}^{2} ( {sin}^{2} ϕ ( \frac{{b}_{e}}{{a}_{e}} ) {cos}^{2} ϕ ) + 2 {G}_{x} {G}_{y} cos ϕ sin ϕ ( 1 - ( \frac{{b}_{e}}{{a}_{e}} ) )$$

wherein

g(φ) describes the column orientation in the unit cell, and

bₑ and aₑ are dimensions of the rods given by the major and minor axes, wherein the micro-cavity array is arranged to provide a resonance output in response to the phase of signals passed by respective waveguides.

In a seventh aspect of embodiments described herein there is provided a crystal for converting phase variations between distinct signals into amplitude variations, the photonic crystal comprising at least two input waveguides and at least one micro-cavity array,

wherein the crystal is adapted to allow, each signal to pass through respective input waveguides to a micro-cavity array,

and wherein in response to the relative phase between the signals, the micro-cavity array creates low group velocity bright or high group velocity dark states,

and wherein the excited micro-cavity array transmits power to an output waveguide, the amplitude being a function of the relative phase difference between the signals.

Typically, maximum power is transmitted to the output waveguide when the relative phase between the two signals is 180° and minimum power is transmitted to the waveguides when the signals are in-phase. Typically there is a slow change of transmitted power as a function of their relative phase (a rate of about 0.27% of the total input power for each degree change in the relative phase). Also, the phase detector will typically have phase symmetry with respect to 180°, that is, it produces the same amount of transmitted power for angles θ and θ+180°.

With respect to optical signals, coherent detection is sensitive to the phase and amplitude of a signal and it can be used to detect phase-encoded modulation formats like binary phase shift keying (BPSK), quadrature phase shift keying (QPSK) and quadrature amplitude modulation (QAM). Sensitivity is dependent on the power coupling efficiency between the input waveguides and the cavity array of the phase detector, where ‘whispering gallery like modes’ are created. Therefore the invention can be used in coherent detection in optical communication systems by further optimization to achieve a high coupling efficiency in to the cavity array.

In an eighth aspect of embodiments described herein there is a provided a signal from an output waveguide of a crystal, preferably a photonic crystal, the signal comprising amplitude variations corresponding to phase variations between distinct input signals, wherein the input signals pass through an input waveguide to a micro-cavity array, and in response to the relative phase between the signals, the micro-cavity array creates low group velocity bright or high group velocity dark states from the input signals, and the excited cavities transmit the signal to the output waveguide.

Preferably the output signal may be embodied in the form of an optical waveform or, an electrical waveform, or an electrical waveform that has been converted from the optical domain.

The embodiments of the present invention can be used as, or as part of, numerous devices for a wide range of purposes including communication, measurement, detection, sensing and imaging. Relevant devices include, but are not limited to interferometers, logic gates, chips, modulators, demodulators, phase comparators, phase recovery devices, amplifiers, repeaters, and band filters.

In an ninth aspect of embodiments described herein there is a provided an apparatus adapted to measure the phase between two signals, said apparatus including processor means adapted to operate in accordance with a predetermined instruction set, and wherein said apparatus, in conjunction with said instruction set, is adapted to perform any of the methods previously described.

Other aspects and preferred forms are disclosed in the specification and/or defined in the appended claims, forming a part of the description of the invention.

In essence, embodiments of the present invention stem from the realization that the ability to forbid the propagation of light in a certain wavelength range (periodic bandgap effect) can be used to engineer the flow of light in many different ways. Specifically, introduction of defects to these structures enable one to inject or extract light in a controlled way. Thus, by introducing defects, it is possible to create optical waveguides and cavities in micro-scale and nano-scale ranges and couple these structures to conventional optical devices.

Advantages provided by the present invention comprise the following:
devices can be fabricated in a compact size which will allow significant extension of the range of applications for this type of technology from the communications sphere to other industries including computing, defence, food technology, pharmacology, medicine and biology;
multiple devices can be integrated into a single small package (e.g. chip-scale application) which can be used in any circuitry;
can be operated in a single frequency, allowing the demodulation of several signals on the same chip;
no modulation of the frequency of the transmitted signal;
an external power input is not required;
can measure phase difference in the optical domain without the need for conversion into the electrical domain, thus enabling connectivity between two optical devices (i.e. optical-to-optical) without optical-electrical-optical connections;
can be used for coherence quality measurements, such as for optical communications;
enhanced SNR in the system (which in optical communication systems reduces the BER thus enhancing the signal quality;
very high phase sensitivity;
can be used for signals across a range of wavelengths including the visible, radio frequency and UV sectors of the electromagnetic spectrum; and
can be used with other resonators.

As mentioned above embodiments of the present invention can potentially be applied to a wide range of new (and existing) applications including, but not limited to the following:

a. Communication, including,
i. Modulation and demodulation equipment,
ii. Phase comparators and phase recovery devices,
iii. Optical amplifiers, and
iv. Optical repeaters.

b. Measuring devices, including,
i. Coherence quality measurement devices,
ii. Laser distance measuring devices,
iii. Laser displacement measuring devices (particularly for displacements of few millimetres and less), and
iv. Laser leveling equipment.

c. Sensors, principally in,
i. High sensitive optical sensors for gas or liquid sensing,
ii. Contamination detectors for measuring the difference between a control sample and test sample,
iii. Bio sensors which use optical signals (such as DNA analysis machines),
iv. spectrometers such as MRI scanners, and X-ray machines.

For example, the present invention could be applied to the following:
(a) quality control, wherein the presence of contamination such as bacteria can be detected by measuring the phase shift (typically caused by difference in refractive indexes) between an uncontaminated control samples and a potentially contaminated test sample. This could be applied to myriad industries including the food, pharmaceutical and medical diagnostic industries;
(b) phase contrast imaging, wherein phase maps are used to create the image of very small particles (such as bio cells);
(c) measurement of coherence quality (ie the ability of a wave to produce interference) in optical communication systems.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates the basic configuration of a DPSK demodulator in accordance with an embodiment of the present invention.

FIG. 2 illustrates (a) an epitaxial structure used to vertically confine light in the core region according a preferred embodiment and (b) DPSK demodulator layout on a square lattice photonic crystal structure according to another embodiment of the present invention.

FIG. 3 illustrates (a) the magnetic field (H_{y}) spectrum at the center of the output waveguide (E) of a preferred embodiment; (b) the magnetic field distribution (H_{y}) for out-of-phase sources according to preferred embodiments and (c) the magnetic field distribution (H_{y}) for in-phase sources according to preferred embodiments. In figures (b) and (c), λ=1038 nm.

FIG. 4 illustrates the relative power transmitted into the waveguide of FIG. 3(a) as a function of the relative phases between the sources, at λ=1038 nm.

FIG. 5 illustrates the extinction ratio as a function of the power ratio in the output arms of the power divider of a preferred embodiment.

FIG. 6 illustrates, for preferred embodiments of the invention, the extinction ratio as a function of the number of cavities for a peak close to λ=1040 nm.

FIG. 7 illustrates (a) the quality factor of the peak close to λ=1040 nm as a function of the number of holes between adjacent cavities (N_{cav}) in an optical phase detector of a preferred embodiment and (b) Extinction ratio as a function of N_{cav}.

FIG. 8 illustrates (a) out-of-phase coupling efficiency as a function of the number of holes between the input waveguides (A and B) and the first micro-cavity in the array (N_{cg}) of an optical phase detector of a preferred embodiment and (b) the magnetic field distribution (H_{y}) for the situation when the sources of an optical phase detector of a preferred embodiment are out-of-phase and N_{cg}=3.

### DETAILED DESCRIPTION

In a recent article (P. Chak, J. K. S. Poon, and A. Yariv, Optical bright and dark states in side-coupled resonator structures, Opt. Letters 32, 1785-1787 (2007)) Chak and co-workers showed that it was possible to create dark and bright states in photonic crystal micro-cavity arrays. These arrays could create low group velocity bright and high group velocity dark states. The creation of these states depended upon the relative phase between the sources. It has now been found that these arrays can be used as phase detectors by modifying the multi-cavity array to enable it to detect the relative phase between two optical sources. The modification of the multi-cavity array enables detection of the relative phase between two optical sources, with potential applications to the demodulation of DPSK signals.

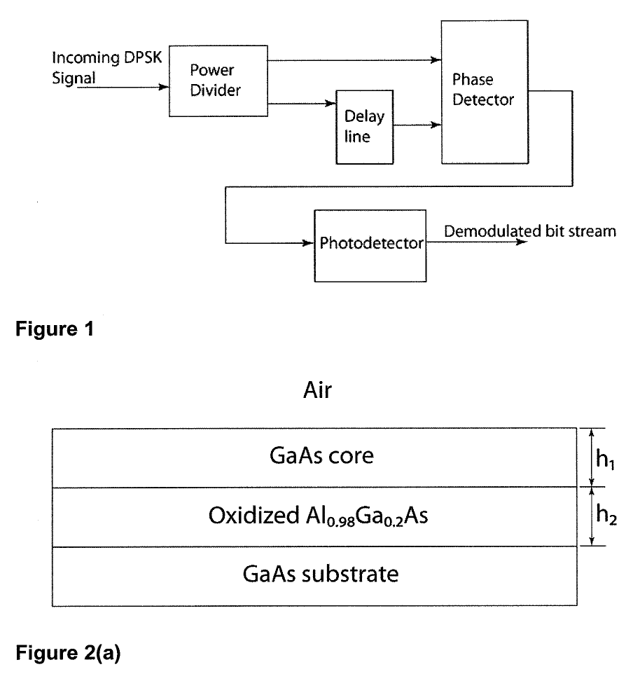

The system illustrated in FIG. 1 is suitable for converting this phase detector of the prior art into a DPSK demodulator. FIG. 1 illustrates the incoming DPSK signal being divided into two signals with equal power levels by a 3 dB splitter, but with one of the signals being further delayed by a bit period with a delay line (an optical fiber cable, for example). These two signals (the direct and the delayed DPSK signals) enter the phase detector. The phase detector will convert the relative phase information between these two signals into an on-off shift-keying stream. This on-off shift-keying stream can then be easily demodulated by a photodetector and the original information can be recovered. In this article, we will limit our analysis to the phase detector.

### Analysis of the Phase Detector

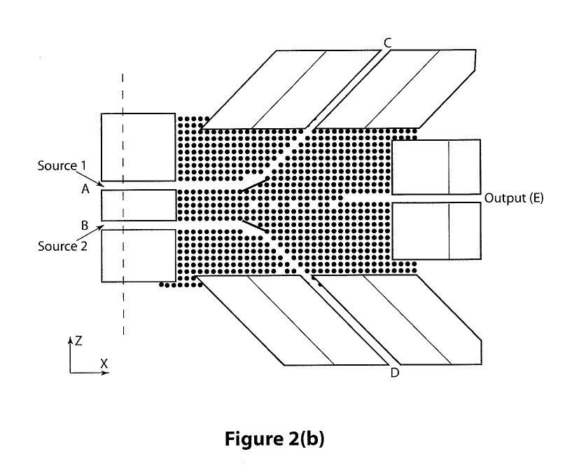

In order to confine light in the vertical direction, the epitaxially layered structure shown in FIG. 2(a) may be used. The structure consists of a GaAs core, an oxidized lower cladding and a GaAs substrate. The thickness of the GaAs core is 140 nm and the thickness of the oxidized layer is 450 nm (before oxidation takes place). The oxidized and air regions confine light in the GaAs core region. This epitaxially layered structure is designed to operate under TE modes, with main magnetic field component along the y-direction (see FIG. 2(b) for details about the Cartesian coordinates employed). Because of the large dimensions of this phase detector, simulations were based upon two-dimensional Finite-Difference Time-Domain (FDTD) methods, with an effective index of 2.82.

The photonic crystal in which the phase detector is built consists of a square lattice of air holes with lattice constant [symbol] =317 nm. The air holes have a radius of 120 nm. In order to assess the performance of this phase detector, two sources were placed in the same x-position but in different input waveguides (A and B). These input waveguides transported the optical fields to the single-defect cavity array as shown in FIG. 2(b). Depending upon the relative phase between these sources, the cavities will be either excited (bright state) or non-excited (dark state).

In the dark state, the coupled resonators are not excited by the two input waveguides, while in the bright states, these coupled cavities are excited. Since the excitation of these states depend upon the relative phase of the input signals, this property is key to operation of the phase detectors.

Two small slots are provided close to the bends of the input waveguides to optimize the transmission of light through the bends. If light is not coupled into the cavities, they will continue to propagate into the bent waveguides without suffering much reflection. Moreover, it may indirectly contribute to the coupling of light into micro-cavities.

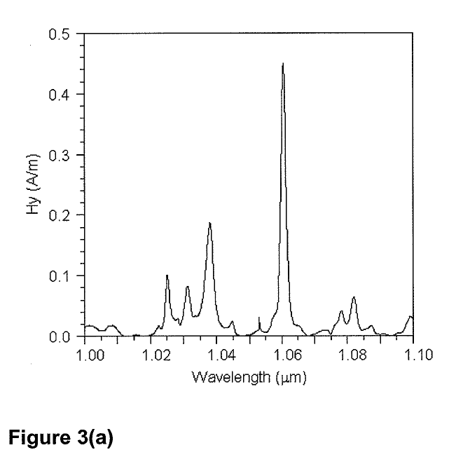

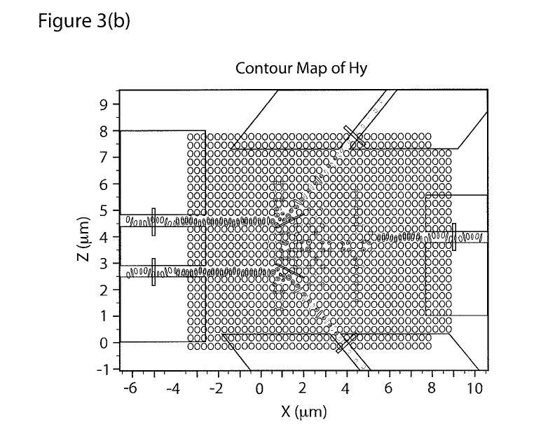

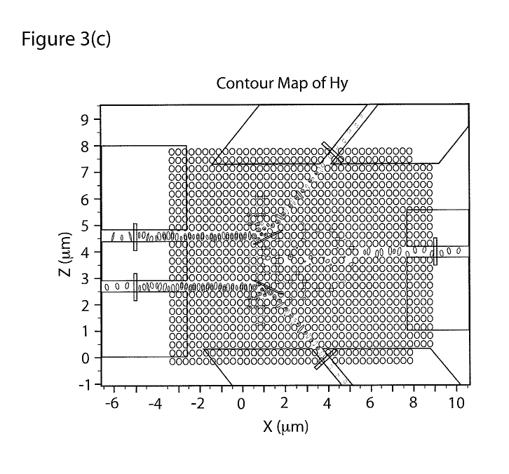

A single-defect micro-cavity in a square lattice of air holes has just a whispering gallery mode in its bandgap region. This mode has odd symmetry with respect to the x-axis, i.e., the four lobes of this mode have opposite phases with respect to the center of the cavity and to the x-axis. Hence it can be expected that if the sources are in-phase, they will not strongly excite these cavities, but if they have opposite phases, the cavities will be strongly excited and will carry power into the output waveguide (E). This is observed for the phase detector shown in FIG. 2(b). The spectrum at the output waveguide (E) is shown in FIG. 3(a). The main peak appears at λ=1038 nm (λ is the free-space wavelength), with a quality factor of 650. There is another peak at λ=1060 nm, but the PhC is off its bandgap region. At λ=1038 nm and when the sources are out-of-phase, about 51% of the total input power is coupled into the output waveguide, as can be observed in FIG. 3(b). Now, when these sources are in-phase at λ=1038 nm, only 2% of the input power is coupled into the waveguide, as can be observed in FIG. 3(c). Hence, this phase detector will be able to convert relative phases into relative amplitudes, with extinction ratios (ratio of power at high level to the power at low level) higher than 20. The extinction ratio (ER) is defined as,

$$ER = \frac{{P}_{{180}^{0}}}{{P}_{{0}^{0}}} \qquad equation ( 1 )$$

Where P₁₈₀_{⁰} is the transmitted power into the waveguide when the two sources are out-of-phase and P₀_{⁰} is the transmitted power into the waveguide when the two sources are in-phase.

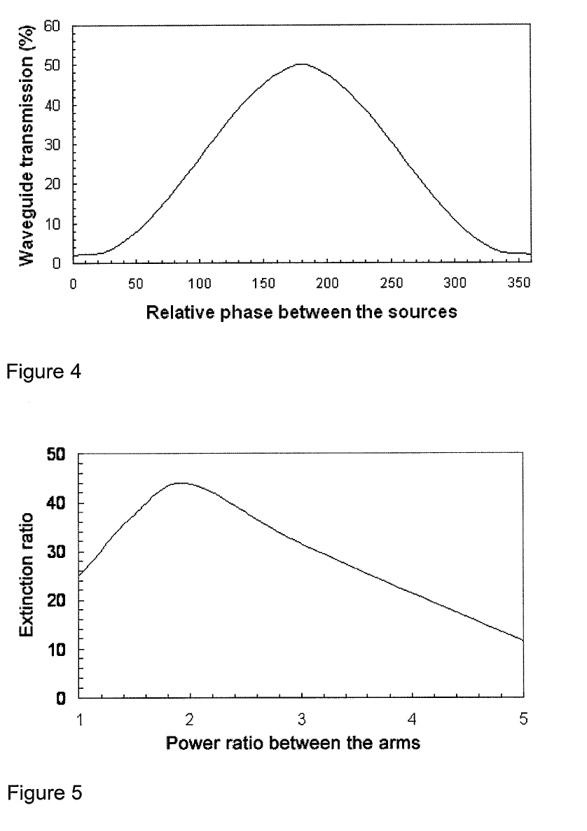

The relative power transmitted into the output waveguide as a function of the relative phase between the sources is shown FIG. 4. The maximum power is transmitted to the waveguide when the relative phase between the two sources is 180° degrees and the minimum power is transmitted to the waveguides when the sources are in-phase. Based upon the curve presented in FIG. 4, it can be observed that the phase detector is not very sensitive to changes in the relative phase between the sources; in fact there is a slow change of the transmitted power as a function of their relative phase (a rate of about 0.27% of the total input power for each degree change in the relative phase). Also, this phase detector has phase symmetry with respect to 180°, i.e., it produces the same amount of transmitted power for angles θ and θ+180°.

In some situations, the power divider in FIG. 1 can be unbalanced and un-evenly divide the power in the output ports. Accordingly, it is worth considering the dependence of an un-equal power in the output arms of the power divider on the extinction ratio of the phase detector. The power ratio is defined as the power in the output with highest power divided by the power in the other output port. Initially, an un-even distribution of power improves the extinction ratio (reaching a maximum for a power ratio of two), but eventually decreases as the power ratio increases as shown in FIG. 5. At high values of power ratio, the power in one of the sources will be much larger than in the other port, enabling the excitation of the micro-cavities despite the phase between the sources (the dark state seems to be the result of the interference between the two sources).

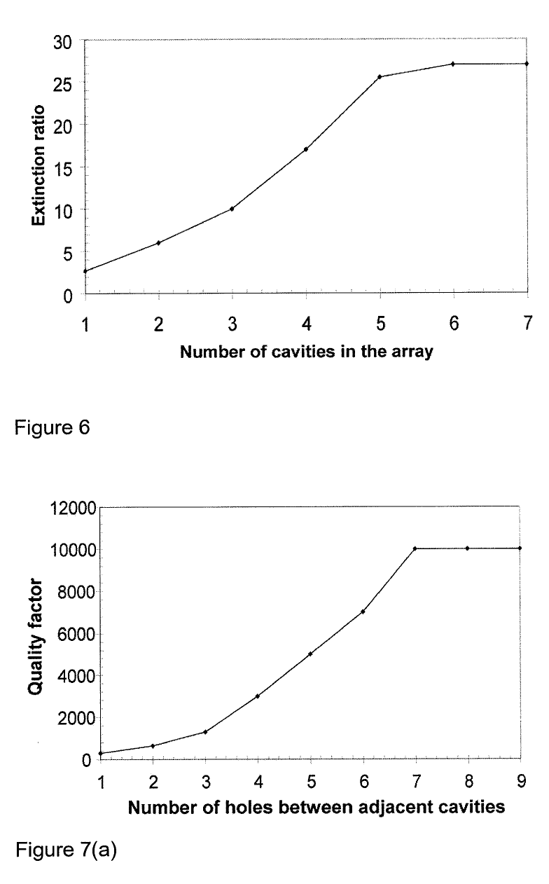

The number of cavities in the phase detector also influences its performance. For example, if there is just a single cavity in the phase detector, power can be directly coupled into the waveguide and not via the single-defect PhC micro-cavity. In this case, the extinction ratio is just 2.7 because of parasitic coupling into the waveguide. FIG. 6 shows the extinction ratio as a function of the number of cavities at a wavelength close to 1040 nm. It can be observed that for a few cavities, the extinction ratio is low because of parasitic coupling into the waveguide, but it reaches saturation after five cavities in the phase detector (the saturation can be explained by the “considerable” reduction of the parasitic coupling into the output waveguide). The number of peaks in the wavelength range between λ=1000 nm and λ=1100 nm also depends upon the number of micro-cavities, in general, the greater the number of micro-cavities the larger is the number of resonant peaks in this wavelength range. The peak close to λ=1040 nm changes from λ=1033 nm and λ=1038 nm, but without any general trend with the number of micro-cavities in the array, i.e., the peak wavelength oscillates between being blue-shifted and red-shifted with the number of cavities.

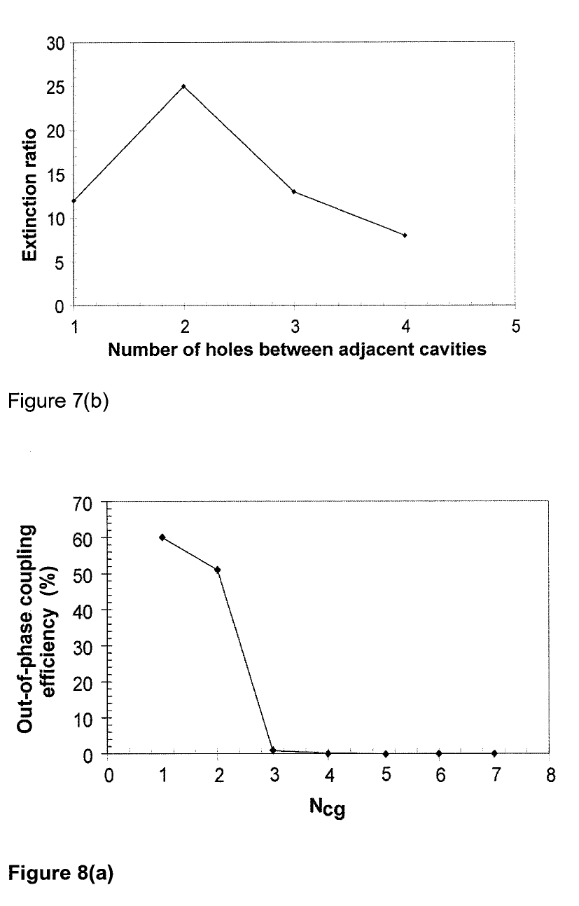

The number of holes between distinct micro-cavities in the array (N_{cav}) defines the spacing and coupling strength between the different cavities. N_{cav} affects the quality factor (Q) of the peak around λ=1040 nm and the number of peaks in the phase detector. Q increases with the number of holes between the cavities until the point when the cavities are weakly coupled and act as nearly independent resonators, leading to a saturation of Q. This can be clearly observed in FIG. 7(a). Apparently, if the coupling is stronger, it is easier to “lose” power into the waveguide, leading to lower values of Q.

ER is also affected by the number of holes between adjacent micro-cavities. In case of 1 hole between adjacent cavities, light can be easily coupled into the waveguide, either for a dark or a bright state, resulting in low value of ER. ER increases when the number of holes between adjacent cavities increases, reaching a maximum value for N_{cav}=2. When N_{cav} is greater than two, less power is coupled into the waveguide in the bright state, leading to lower values of ER. This can be clearly observed in FIG. 7(b), where ER starts to decrease for N_{cav}>2.

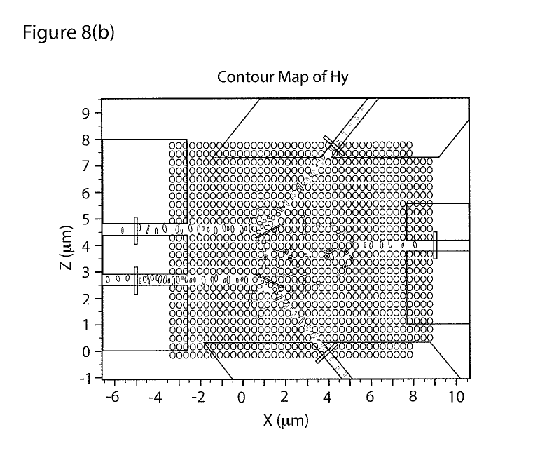

Analysis of the effects of having different number of holes between the input cavities and the first micro-cavity in the array (N_{cg}). N_{cg} determines the coupling strength into the micro-cavity array. If the coupling is strong, light will be easily coupled into the micro-cavities array, otherwise light will prefer to propagate through the bent input waveguides (C and D). FIG. 8(a) shows the percentage of the total input power that is coupled into the waveguide when the sources are out-of-phase. From this Figure, it can be seen that light can be easily coupled into the output waveguide (E) when the number of holes (N_{cg}) are 1 or 2. However, when N_{cg}>2, the coupling into the micro-cavities array is difficult and light “prefers” to continue in the bent waveguides (C and D). FIG. 8(b) shows the magnetic field distribution at λ=1038 nm and when the sources are in-phase. Although the micro-cavities are still excited, not much power flows into the output waveguide, the power flowing through the bent waveguides (C and D) are significantly higher since it is easier for light to continue in the waveguide.

Based upon the results described above, it is apparent that the device can operate as a phase detector and can be used in DPSK demodulators.

### Design of the Photonic Crystal

The structure of the photonic crystal of the present invention may be designed and scaled to operate at the desired frequency with a desired material combination. In particular, the scaling properties inherent in Maxwell's equation may be applied to photonic crystal design, as has been illustrated by the prior art work of Joannopoulos et al, in Photonic Crystals: Molding the Flow of Light, 2nd edition, (2008).

### Scaling Properties of Maxwell's Equation

As mentioned in Joannopoulos et al, with respect to electromagnetism in dielectric media, there is no fundamental length scale other than the assumption that the system is macroscopic. The spatial scale of the potential function is generally set by the fundamental length scale of the Bohr radius and means that configurations of material that differ only in their overall spatial scale can have very different physical properties. Photonic crystals do not have a fundamental constant with the dimensions of length and therefore the master equation is scale invariant. Accordingly relationships between electromagnetic problems are simple and differ only by a contraction or expansion of all distances.

For example, for an electromagnetic eigenmode H(r) of frequency ω in a dielectric configuration ∈(r) the master equation is as follows:

$$∇ \times ( \frac{1}{ɛ ( r )} ∇ \times H ( r ) ) = {( \frac{ω}{c} )}^{2} H ( r ) \qquad equation ( 2 )$$

When the dielectric configuration is ∈̅(r) the harmonic mode is a compressed or expanded version of ∈(r) where ∈̅(r)=∈(r/s) for some scale parameter s. If the variables of 1 are changed, using r̅=sr and ∇̅=∇/s the new equation is as follows:

$$s \overline{∇} \times ( \frac{1}{ɛ ( \overline{r} / s )} s \overline{∇} \times H ( \overline{r} / s ) ) = {( \frac{ω}{c} )}^{2} H ( \overline{r} / s ) \qquad equation ( 3 )$$

Given that ∈( r̅/s) is equivalent to ∈̅( r̅) dividing out equation (3) provides,

$$\overline{∇} \times ( \frac{1}{ɛ ( \overline{r} )} s \overline{∇} \times H ( \overline{r} / s ) ) = {( \frac{ω}{cs} )}^{2} H ( \overline{r} / s ) \qquad equation ( 4 )$$

Equation (4) is the same equation as equation (3), but with mode profile H̅( r̅)=H( r̅/s) and frequency ω̅=ω/s hence the new mode profile and its corresponding frequency can be obtained by simply rescaling the old mode profile and its frequency.

### Scaling of a Photonic Crystal

By applying the principle described above a photonic crystal suitable for use in the present invention may be designed. For example, a photonic crystal can be designed for use in a phase detector intended to operate at a frequency of ω₁. If the design parameters of the photonic crystal are r₁ and a₁ (where r₂ is the radius of an air hole and a₂ is the length between the central points of two air holes).

If a photonic crystal of the same material is required, but having a different operational wavelength, ω₂, then the scaling parameter required to scale the design parameters is as follows,

ω₂=Sω₁ equation (5)

and the new scaled design parameters (r₂, a₂) will be,

r₂=Sr₁

a₂=Saₗ equation (6)

The design parameters must be scaled with the constant where the frequency was scaled. By doing so the fundamental ratio (a₁/r₁=a₂/r₂) does not change.

This scaling can be performed for the structure to operate at any frequency. Accordingly it is possible to test the structure for the microwave frequency and fabricate in optical frequency or the inverse.

In addition to changing the operating frequency from ω₁ to ω₂, the material used for fabrication may also be changed. In doing so, the operating frequency of the original structure will be shifted by a constant that can be calculated as described in equation (2).

If a structure is operating at frequency ω₁ with the dielectric constant of ∈₁ and the new dielectric constant is ∈₂ then the expected frequency shift can be calculated as follows,

$$\frac{{ɛ}_{2}}{{ɛ}_{1}} = γ \qquad equation ( 7 )$$

where γ is a constant. Therefore, the new frequency, ωᵢ (where ωᵢ is an intermediate frequency) can be calculated from,

$$\frac{{ɛ}_{i}}{{ɛ}_{1}} = k γ \qquad equation ( 8 )$$

where k is an arbitrary constant.

Since the structure is required to operate at the frequency ω₂, it is also necessary to change the structural parameters (a, r) from frequency ωᵢ to ω₂. Then,

$$\frac{{ω}_{2}}{{ω}_{i}} = Γ \qquad equation ( 9 )$$

Therefore the structural parameters must be changed such that,

r₂=Γr

a₂=Γa equation (10)

Using this method, first a frequency shift is calculated by introducing a new dielectric and then the frequency is shifted to the desired frequency by changing the structural parameters. By doing so, it is possible to design a new structure with new material to operate in any frequency that is required.

### Materials for Fabrication of the Photonic Crystal

The fabrication of a suitable photonic crystal structure can be carried out using any dielectric material. However, the person skilled in the art will appreciate that it may be desirable to avoid the selection of a dielectric having an imaginary constant in the dielectric constant. Table 1 sets out a few examples of commonly used dielectrics with their refractive index for a single frequency close to λ=1040 nm.

TABLE 1

| | |
|---|---|
| Material | Refractive Index (n) |

Wavelength: λ = 1040 nm to λ = 1300 nm

| | |
|---|---|
| Gallium Arsenide (GaAs) | 3.489 |
| Indium Phosphide (InP) | 3.311 |

Wavelength: λ = 1310 nm to λ = 1550 nm

| | |
|---|---|
| Indium Phosphide (InP) | 3.311 |
| Aluminium Gallium Arsenide (AlGaAs) | 3.437 |
| Aluminium Gallium Arsenide | 3.43 |
| Phosphide (AlGaAsP) | |
| Indium Gallium Nitride (InGaN) | 2.33 |

Wavelength: λ < 400 nm

| | |
|---|---|
| Zinc Oxide (ZnO) | nᵣₑₐₗ = 2.26, n_{Imag} = 0.016. |
| Lithium Iodate (LiIO₃) | nᵣₑₐₗ = 1.82963, n_{Imag} = 1.68868 |
| Indium Arsenide (InAs)- | nᵣₑₐₗ = 3.615, n_{Imag} = 0.29 |
| Silicon (Si) | nᵣₑₐₗ = 3.603, n_{Imag} = 0.0033 |

### Lattice Constant

The lattice constant can be changed to suit any operating frequency (wavelength) at which the crystal may operate.

For example, with reference to a GaAs crystal operating at a wavelength of 1040 with lattice constant [symbol] =317 nm and air hole radius of 120 nm, lattice constants and radius of holes can be calculated for other operating wavelengths by scaling using a scaling factor of 1 (ω₂/ω₁=1). Exemplary values are set out in Table 2. The [symbol] /r ratio is the kept the same after scaling to the new frequency.

TABLE 2

| | | Lattice | | |
|---|---|---|---|---|
| | Scaling | constant | Hole radius r | |
| Operating | factor | New [symbol] = [symbol] *S | r = [symbol] * 0.3785 | |
| wavelength | (S) | (nm) | (nm) | r/ [symbol] |
| 1040 | 1 | 317 | 120 | 0.3785 |
| 980 | 0.9423 | 300 (298.7091) | 115 (113.0746) | 2.6417 |
| 1310 | 1.2596 | 400 (399.2932) | 150 (151.1501) | 2.6417 |
| 1550 | 1.4904 | 475 (472.4568) | 180 (178.8457) | 2.6417 |

### Generalized Formulation for Photonic Crystal Structures

Prior art document Hillebrand et al, ‘Band gap studies of triangular 2D photonic crystals with varying pore roundness’, Solid State Communications, Volume 115, Issue 5, 19 Jun. 2000, pages 227-232 describes studies of photonic crystals which is background to the present invention.

The master equation (2) can be derived by solving Maxwell's equation for the magnetic field H(r). Where ω is the frequency of light and c is the speed of light.

For the analysis of the air hole distribution in the photonic crystal an analytical solution have been derived for the Fourier transformation (∈⁻¹) for elliptical columns, ∈ₛ the dielectric constant of the columns and ∈_{b} is the background dielectric constant. In this formulation n is the refractive index in the material (n=√∈). The elliptical columns may show different orientations with respect to the lattice. The dimensions of the rods are given by the major and minor axes (bₑ, aₑ) resulting in an eccentricity of e=aₑ/bₑ. In the case of circular cylindrical air holes, as in our case, e=1 (that is, bₑ=aₑ). For the objective of forming a general formulation for the relation between the material properties (dielectric constant or refractive index), the Fourier transform ∈⁻¹ (G) for the real structure can be can be written as;

$${ɛ}^{- 1} ( G ) = \frac{1}{ɛ} {δ}_{G , 0} + ( \frac{1}{{ɛ}_{s}} - \frac{1}{{ɛ}_{b}} ) {γ}_{e} \frac{2 {J}_{1} ( {a}_{e} \sqrt{g ( ϕ )} )}{{a}_{e} \sqrt{g ( ϕ )}} \qquad equation ( 11 )$$

Here J₁ is a Bessel function of the first kind and the factor γₑ is the filling factor. It related all the dimensions of the structure to the material properties.

γₑ=2πaₑbₑ/(a²\sqrt{3}) equation (12)

The factor γₑ describes the ratio of the area of the column to the area of the total unit cell. Function g(φ) describes the orientation of the column in the unit cell.

$$g ( ϕ ) = {G}_{x}^{2} ( {cos}^{2} ϕ + ( \frac{{b}_{e}}{{a}_{e}} ) {sin}^{2} ϕ ) + {G}_{y}^{2} ( {sin}^{2} ϕ ( \frac{{b}_{e}}{{a}_{e}} ) {cos}^{2} ϕ ) + 2 {G}_{x} {G}_{y} cos ϕ sin ϕ ( 1 - ( \frac{{b}_{e}}{{a}_{e}} ) ) \qquad equation ( 13 )$$

The dispersion properties of 2D photonic crystals are basically determined by the dielectric contract, the lattice type, for example square or triangular, and the lattice filling ratio.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

It should be noted that where the terms “detector”, “optical detector” or similar terms are used herein, a communication device is described that may be used in a communication system, unless the context otherwise requires, and should not be construed to limit the present invention to any particular communication device type. Thus, a communication device may include, without limitation logic gates, sensors and band filters.

It should also be noted that where a flowchart or equivalent illustration of processes or systems is used herein to demonstrate various aspects of the invention, it should not be construed to limit the present invention to any particular logic flow or logic implementation. The described logic may be partitioned into different logic blocks without changing the overall results or otherwise departing from the true scope of the invention. Often, logic elements may be added, modified, omitted, performed in a different order, or implemented using different logic constructs without changing the overall results or otherwise departing from the true scope of the invention.

Hardware logic (comprising programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

‘Comprises/comprising’ and Includes/including' when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A method of arranging the structure of a crystal to measure the phase between at least two signals, comprising the steps of (i) providing a respective waveguide for each signal, and (ii) providing a micro-cavity array arranged to provide a resonance output in response to the phase of the signals.

2. A method according to claim 1 wherein the structure is chosen from the group comprising two-dimensional structures or three-dimensional structures.

3. A method according to claim 2 wherein the structure is three-dimensional and includes at least two micro-cavity arrays.

4. A method of arranging the structure of a crystal to measure the phase between two signals comprising the steps of;
(i) providing input waveguides adapted to pass respective signals,
(ii) providing a first cavity adapted to pass a characteristic of at least one signal, and
(iii) providing an output waveguide adapted to pass an output signal based on the characteristic of the at least one signal.

5. A method of arranging the structure of a photonic crystal to measure the phase between two signals comprising the steps of;
(i) providing input waveguides adapted to pass respective signals,
(ii) providing a first cavity adapted to pass a characteristic of at least one signal, and
(iii) providing an output waveguide adapted to pass an output signal based on the characteristic of the at least one signal.

6. A method according to claim 4 or claim 5 wherein the structure is chosen from the group comprising two-dimensional structures or three-dimensional structures.

7. A crystal having a structure arranged according to the method of any one of claim 1, 4 or 5.

8. A crystal having a structure arranged according to the method of any one of claim 1, 4 or 5 wherein the crystal comprises elements chosen from one or more members of Group 1 Group 5, Group 6, Group 7, Group 8 or Group 9 of the periodic table.

9. A crystal having a structure arranged according to the method of any one of claim 1, 4 or 5 wherein the crystal is fabricated of material chosen from the group comprising GaAs, InP, AlGaAs, AlGaAsP, InGaN, ZnO, LiIO₃, InAs or Si.

10. A method of measuring the phase between two signals, comprising the steps of passing the signals through two respective waveguides and a micro-cavity array in a crystal and measuring the resonance output in response to the phase of the signals.

11. A method of measuring the phase between two signals, comprising the step of passing each signal through respective input waveguides, a micro-cavity array and an output waveguide, the amplitude of the power passing through the output waveguide being dependent on the relative phase difference between the signals.

12. A method according to claim 10 or claim 11 wherein one of said signals is derived from a test sample and the other of said signals is derived from a control sample.

13. A method of arranging a crystal comprising at least one waveguide and at least one micro-cavity array, including the step of calculating the structure of the photonic crystal in accordance with Maxwell's equation, wherein the micro-cavity array is arranged to provide a resonance output in response to the phase of signals passed by respective waveguides.

14. A method of arranging a crystal comprising at least one waveguide and a micro-cavity array, including the step of calculating the structure of the photonic crystal in accordance with Maxwell's equation, wherein the micro-cavity array is arranged to provide a resonance output in response to the phase of signals passed by respective waveguides and wherein the crystal is a photonic crystal.

15. A method of arranging a crystal, comprising at least one waveguide and a micro-cavity array, including the step of calculating the structure of the crystal by applying the relationship
$$g ( ϕ ) = {G}_{x}^{2} ( {cos}^{2} ϕ + ( \frac{{b}_{e}}{{a}_{e}} ) {sin}^{2} ϕ ) + {G}_{y}^{2} ( {sin}^{2} ϕ ( \frac{{b}_{e}}{{a}_{e}} ) {cos}^{2} ϕ ) + 2 {G}_{x} {G}_{y} cos ϕ sin ϕ ( 1 - ( \frac{{b}_{e}}{{a}_{e}} ) )$$
wherein
g(φ) describes the column orientation in the unit cell, and
bₑ and aₑ are dimensions of the rods given by the major and minor axes, wherein the micro-cavity array is arranged to provide a resonance output in response to the phase of signals passed by respective waveguides.

16. A crystal for converting phase variations between distinct signals into amplitude variations, the photonic crystal comprising at least two input waveguides and at least one micro-cavity array,
wherein the crystal is adapted to allow each signal to pass through respective input waveguides to a micro-cavity array,
and wherein in response to the relative phase between the signals, the micro-cavity array create low group velocity bright or high group velocity dark states,
and wherein the excited micro-cavity array transmits power to an output waveguide, the amplitude being a function of the relative phase difference between the signals.

17. An apparatus comprising a crystal according to claim 16.

18. An apparatus comprising a photonic crystal according to claim 16 and chosen from the group comprising interferometers, logic gates, chips, modulators, demodulators, phase comparators, phase recovery devices, amplifiers, repeaters, and band filters.

19. An apparatus comprising a crystal according to claim 16 when used for an activity chosen from the group comprising communication, measurement, detection, sensing, imaging or combinations thereof.

20. A signal from an output waveguide of a photonic crystal, the signal comprising amplitude variations corresponding to phase variations between distinct input signals, wherein the input signals pass through an input waveguide to a micro-cavity array, and in response to the relative phase between the signals, the micro-cavity array creates low group velocity bright or high group velocity dark states from the input signals, and the excited cavities transmit the signal to the output waveguide.

21. Apparatus adapted to measure the phase between two signals said apparatus including processor means adapted to operate in accordance with a predetermined instruction set, and wherein said apparatus, in conjunction with said instruction set, is adapted to perform the method as claimed in claim 8.

22. Apparatus adapted to measure the phase between two signals said apparatus including processor means adapted to operate in accordance with a predetermined instruction set, and wherein said apparatus, in conjunction with said instruction set, is adapted to perform the method as claimed in claim 9.

23. An apparatus comprising a crystal for converting phase variations between distinct signals into amplitude variations, the photonic crystal comprising at least two input waveguides and at least one micro-cavity array,
wherein the crystal is adapted to allow each signal to pass through respective input waveguides to a micro-cavity array,
wherein in response to the relative phase between the signals, the micro-cavity array create low group velocity bright or high group velocity dark states, and
wherein the excited micro-cavity array transmits power to an output waveguide, the amplitude being a function of the relative phase difference between the signals,
said apparatus including processor means adapted to operate in accordance with a predetermined instruction set, said apparatus, in conjunction with said instruction set, being adapted to perform a method of arranging the structure of a crystal to measure the phase between at least two signals, comprising the steps of (i) providing a respective waveguide for each signal, and (ii) providing a micro-cavity array arranged to provide a resonance output in response to the phase of the signals.

24. An apparatus comprising a crystal for converting phase variations between distinct signals into amplitude variations, the photonic crystal comprising at least two input waveguides and at least one micro-cavity array,
wherein the crystal is adapted to allow each signal to pass through respective input waveguides to a micro-cavity array,
wherein in response to the relative phase between the signals, the micro-cavity array create low group velocity bright or high group velocity dark states, and
wherein the excited micro-cavity array transmits power to an output waveguide, the amplitude being a function of the relative phase difference between the signals,
said apparatus including processor means adapted to operate in accordance with a predetermined instruction set, said apparatus, in conjunction with said instruction set, being adapted to perform a method of arranging the structure of a crystal to measure the phase between two signals comprising the steps of;
(i) providing input waveguides adapted to pass respective signals,
(ii) providing a first cavity adapted to pass a characteristic of at least one signal, and
(iii) providing an output waveguide adapted to pass an output signal based on the characteristic of the at least one signal.

25. An apparatus comprising a crystal for converting phase variations between distinct signals into amplitude variations, the photonic crystal comprising at least two input waveguides and at least one micro-cavity array,
wherein the crystal is adapted to allow each signal to pass through respective input waveguides to a micro-cavity array,
wherein in response to the relative phase between the signals, the micro-cavity array create low group velocity bright or high group velocity dark states, and
wherein the excited micro-cavity array transmits power to an output waveguide, the amplitude being a function of the relative phase difference between the signals,
said apparatus including processor means adapted to operate in accordance with a predetermined instruction set, said apparatus, in conjunction with said instruction set, being adapted to perform a method of arranging the structure of a photonic crystal to measure the phase between two signals comprising the steps of;
(i) providing input waveguides adapted to pass respective signals,
(ii) providing a first cavity adapted to pass a characteristic of at least one signal, and
(iii) providing an output waveguide adapted to pass an output signal based on the characteristic of the at least one signal.

26. An apparatus as recited in any one of claims 23, 24 and 25 wherein the crystal comprises elements chosen from one or more members of Group 1 Group 5, Group 6, Group 7, Group 8 or Group 9 of the periodic table.

27. A apparatus as recited in any one of claims 23, 24 and 25 wherein the crystal is fabricated of material chosen from the group comprising GaAs, InP, AlGaAs, AlGaAsP, InGaN, ZnO, LiIO₃, InAs or Si.

28. An apparatus as recited in any one of claims 23, 24 and 25 and chosen from the group comprising interferometers, logic gates, chips, modulators, demodulators, phase comparators, phase recovery devices, amplifiers, repeaters, and band filters.

29. An apparatus as recited in claim 26 and chosen from the group comprising interferometers, logic gates, chips, modulators, demodulators, phase comparators, phase recovery devices, amplifiers, repeaters, and band filters.

30. An apparatus as recited in claim 27 and chosen from the group comprising interferometers, logic gates, chips, modulators, demodulators, phase comparators, phase recovery devices, amplifiers, repeaters, and band filters.
